(19) United States
(12) Patent Application Publication
(10) Pub. No.: US 2026/0126811 A1
(43) Pub. Date: May 7, 2026

(54) INTELLIGENT CONTROL METHOD AND AUTONOMOUS MOBILE DEVICE

(71) Applicant: JIANGSU DONGCHENG M&E TOOLS CO., LTD., NANTONG (CN)

(72) Inventor: DONGHUI ZHU, NANTONG (CN)

(21) Appl. No.: 19/437,109

(22) Filed: Dec. 30, 2025

Related U.S. Application Data
(63) Continuation of application No. PCT/CN2025/079744, filed on Feb. 28, 2025.

(30) Foreign Application Priority Data
Mar. 11, 2024 (CN) 202410273120.2

(51) Int. Cl. G05D 1/648; G05D 1/628; G05D 101/10; G05D 105/15; G05D 107/20

(52) U.S. Cl. CPC G05D 1/648; G05D 1/628; G05D 2101/10; G05D 2105/15; G05D 2107/23

(57) ABSTRACT

An intelligent control method and an autonomous mobile device are provided. The intelligent control method includes: during the autonomous mobile device traveling along the planned path, in response to detecting that the autonomous mobile device has reached a boundary line before arriving at a turning point of the planned path, acquiring actual coordinates of a first marker point and preset coordinates of the first marker point within a virtual map, the first marker point is configured to indicate the position where the autonomous mobile device has reached the boundary line, and in response to the actual coordinates of the first marker point being inconsistent with the preset coordinates, activating a calibration process for the planned path to obtain a calibrated planned path.

### CROSS REFERENCE TO RELATED APPLICATIONS

The present disclosure is a continuation of PCT Patent Application No. PCT/CN2025/079744, entitled “INTELLIGENT CONTROL METHOD AND AUTONOMOUS MOBILE DEVICE,” filed on Feb. 28, 2025, which claims priority to Chinese Patent Application No. CN202410273120.2, entitled “INTELLIGENT CONTROL METHOD AND AUTONOMOUS MOBILE DEVICE,” filed on Mar. 11, 2024, which is incorporated by reference herein in its entirety.

### TECHNICAL FIELD

The present disclosure relates to the technical field of robotics, and more specifically to an intelligent control method and an autonomous mobile device.

### BACKGROUND

With the continuous advancement of computer and communication technologies, autonomous mobile devices such as smart lawn mowers have been widely adopted for maintaining residential lawns and trimming large-scale grassy areas. This has greatly streamlined user operations, freeing them from tedious and time-consuming labor.

Most smart lawn mowers use inertial navigation systems. When a smart lawn mower follows pre-planned paths within a virtual map and implements mowing of lawns, the inertial navigation systems gradually drift over time because of factors like wheel slippage, causing increasing positioning errors.

### SUMMARY

Embodiments of the present disclosure provide an intelligent control method, which solves the problem of the autonomous mobile device caused by positioning deviation and other factors.

In a first aspect, some embodiments of the present disclosure provide an intelligent control method, applied to an autonomous mobile device, and the method includes the following operations:
101, causing the autonomous mobile device to perform tasks along a planned path, the planned path being initially set based on a virtual map;
102, during the autonomous mobile device traveling along the planned path, in response to detecting that the autonomous mobile device has reached a first boundary line before arriving at a turning point of the planned path, acquiring actual coordinates of a first marker point and preset coordinates of the first marker point within the virtual map, the first marker point being configured to indicate the position where the autonomous mobile device has reached the first boundary line; and
103, in response to the actual coordinates of the first marker point being inconsistent with the preset coordinates, activating a calibration process for the planned path to obtain a calibrated planned path.

In a second aspect, some embodiments of the present disclosure provide an autonomous mobile device, the device includes:
a boundary detection device, configured to detect a boundary line;
a positioning device, configured to output real-time position information of the autonomous mobile device;
a controller, electrically connected to the boundary detection device and the positioning device, and configured to implement the following operations:
   causing the autonomous mobile device to perform tasks along a planned path, the planned path being initially set based on a virtual map;
   during the autonomous mobile device traveling along the planned path, in response to detecting that the autonomous mobile device has reached a first boundary line before arriving at a turning point of the planned path, acquiring actual coordinates of a first marker point and preset coordinates of the first marker point within the virtual map, the first marker point being configured to indicate the position where the autonomous mobile device reaches the first boundary line; and
   in response to the actual coordinates of the first marker point being inconsistent with the preset coordinates, activating a calibration process for the planned path to obtain a calibrated planned path.

In a third aspect, some embodiments of the present disclosure provide an autonomous mobile device including a memory and a processor. The memory is configured to store computer-executable instructions, and the processor is configured to call the computer-executable instructions in the memory to cause the autonomous mobile device to implement the intelligent control method as described in the first aspect.

### BRIEF DESCRIPTION OF THE DRAWINGS

FIG. 1 is a schematic flow chart of an intelligent control method according to some embodiments of the present disclosure.

FIG. 2 is a first schematic diagram of a planned path according to some embodiments of the present disclosure.

FIG. 3 is a second schematic diagram of a planned path according to some embodiments of the present disclosure.

FIG. 4 is another schematic flow chart of an intelligent control method according to some embodiments of the present disclosure.

FIG. 5 is a schematic diagram of an intelligent control method according to some embodiments of the present disclosure.

FIG. 6 is a schematic diagram of an intelligent control device according to some embodiments of the present disclosure.

FIG. 7 is a schematic diagram of the hardware structure of an autonomous mobile device according to some embodiments of the present disclosure.

### DETAILED DESCRIPTION OF THE EMBODIMENTS

During the implementation of the present disclosure, the inventors found that when autonomous mobile devices such as smart lawn mowers perform mowing tasks along a pre-planned path within a virtual map, the inertial navigation system drifts over time due to factors like wheel slippage. This leads to increasing positioning errors, causing the autonomous mobile device to move beyond the virtual boundary lines before reaching the target position at the virtual boundary. Consequently, there are missed mowing areas, which reduces the operational efficiency of the autonomous mobile device and increases the risk of damage (e.g., collisions) to the autonomous mobile device.

To address the above issues, in some embodiments of the present disclosure, an intelligent control method is provided. The intelligent control method can effectively cause the autonomous mobile device to perform mowing tasks within the boundary.

To make the technical solutions and advantages in the embodiments of the present disclosure clearer and more understandable, the exemplary embodiments of the present disclosure are described in further detail below with reference to the accompanying drawings. Obviously, the described embodiments are only a part of the embodiments of the present disclosure, rather than an exhaustive list of all embodiments. It should be noted that the embodiments and the features within the embodiments of the present disclosure can be combined with one another without conflict.

The terms used in the present disclosure are intended solely for the purpose of describing specific embodiments and are not intended to limit the present disclosure. For example, terms indicating direction or positional relationships such as “upper,” “lower,” “front,” and “rear” are based solely on the orientation or positional relationships shown in the drawings. They are used solely for the purpose of facilitating the description of the disclosure and simplifying the description, and are not intended to indicate or imply that the devices/elements referred to must have a specific orientation or be constructed and operated in a specific orientation. Therefore, they should not be construed as limitations on the disclosure.

The following briefly describes the application environment of the intelligent control method provided by the embodiments of the present disclosure. The intelligent control method is applied to an autonomous mobile device, which includes at least an intelligent lawn mower.

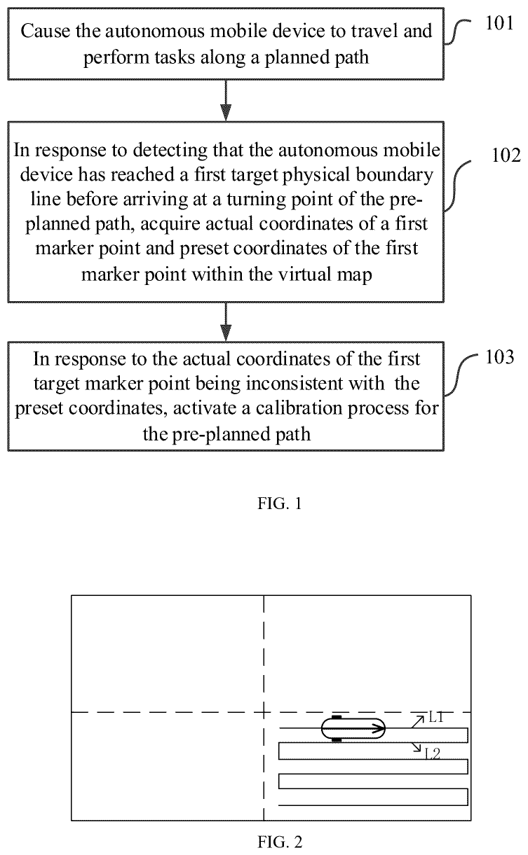

Referring to FIG. 1, the following embodiments take the aforementioned autonomous mobile device as the execution entity and specifically illustrate the application of the method provided herein to said device. An intelligent control method is provided by the embodiments of the present disclosure. The intelligent control method includes the following operations 101 to 103.

In 101, the autonomous mobile device is caused to travel and perform tasks along a planned path, where the planned path is initially set based on a virtual map.

In some embodiments, the autonomous mobile device is caused to travel and perform mowing tasks within a working area bounded by physical boundary lines. It should be understood that the working area is a regular rectangular region or an irregular region of arbitrary shape.

In some embodiments, a radio frequency identification (RFID) tag is installed at a charging station. The autonomous mobile device is configured to, in response to detecting the RFID signal at the charging station, reverse to a specific position, rotate by a certain angle, move onto a left physical boundary line, and travel along the physical boundary line once, and continuously recording its position information. When the autonomous mobile device returns to the charging station and detects the RFID signal again, the virtual map establishment process is completed.

In some embodiments, the working area is divided into sub-working areas based on the established virtual map. Within each sub-working area, multiple positions are set. The position information is sequentially numbered and stored in the memory of the autonomous mobile device. Based on these positions, planned paths are generated within each sub-working area, and the autonomous mobile device is configured to cover each sub-working area according to a predetermined navigation logic sequence, and perform mowing tasks along the planned paths within each sub-working area.

In 102, while the autonomous mobile device is traveling along the planned path, in response to reaching a first physical boundary line before arriving at a turning point of the planned path, actual coordinates of a first marker point and preset coordinates of the first marker point are acquired. The first marker point is configured to indicate the position where the autonomous mobile device has reached the first physical boundary line.

In some embodiments, whether the autonomous mobile device has reached the first physical boundary line is detected by a boundary sensor. The boundary sensor includes, for example, a geomagnetic sensor. Since the physical boundary of the working area is enclosed by an embedded boundary wire that emit a magnetic field signal, the magnetic sensor can detect when the first physical boundary line has been reached.

The autonomous mobile device is configured to, if the autonomous mobile device has not reached the first physical boundary line, continue traveling along the planned path. The autonomous mobile device is configured to, if the autonomous mobile device has reached the first physical boundary line, stop moving forward, make a turn, output the actual coordinates of the first marker point (i.e., the actual coordinates of the autonomous mobile device when the autonomous mobile device has reached the first physical boundary line), and read the preset coordinates from the memory of the autonomous mobile device-specifically, the coordinates within the virtual map that the autonomous mobile device should reach along a current planned path.

It should be understood that the first physical boundary line referred to in some embodiments of the present disclosure denotes the actual boundary of the working area. In some embodiments, a boundary wire capable of emitting magnetic field signals is embedded at the actual boundary of the working area, and the autonomous mobile device determines arrival at the first physical boundary line by detecting magnetic field signals emitted by the first physical boundary line through an on-board geomagnetic sensor. In other embodiments, embedding a boundary wire at the actual boundary of the working area is unnecessary. Instead, the autonomous mobile device directly identifies grass and non-grass areas via an on-board camera to determine arrival at the first physical boundary line.

In 103, in response to the actual coordinates of the first marker point being inconsistent with the preset coordinates, a calibration process for the planned path is activated.

In some embodiments, if the actual coordinates of the autonomous mobile device at the first physical boundary line are inconsistent with the preset coordinates, slippage or drift is indicated to have occurred, resulting in positioning errors for the autonomous mobile device. Consequently, after such a positioning error is determined, continuing to travel along the planned path cause the autonomous mobile device to exit the boundary. Therefore, a calibration process for the planned path is required. This calibration process involves translation processing to pull the planned path back within the boundaries.

The technical solutions provided in the embodiments of the present disclosure have the following benefits: Whether to activate the calibration process for the planned path is determined by the consistency of the actual coordinates of the autonomous mobile device at the point where the autonomous mobile device contacts the physical boundary line and the preset coordinates that the autonomous mobile device should reach within the virtual map. This not only ensures the autonomous mobile device efficiently performs tasks along the planned path, but also prevents the autonomous mobile device from moving beyond the physical boundary line due to factors such as positioning deviations. Consequently, the autonomous mobile device maximizes coverage of the working area, which enhances the operational efficiency of the autonomous mobile device and reduces the risk of damage to the autonomous mobile device.

In some embodiments, the autonomous mobile device also be configured to interact with a terminal, allowing users to observe the position of the autonomous mobile device relative to the actual physical boundary line via the terminal.

The autonomous mobile device is configured to, before activating the calibration process for the planned path, issue an alarm or send an alarm signal to the terminal. The alarm signal includes at least one of a buzzer alarm, vibration, a voice prompt, and LED flashing, which serves to alert the user that the autonomous mobile device is about to exit the boundary.

The intelligent control method further includes: after completing the calibration process for the planned path, causing the autonomous mobile device to travel along a next segment of the calibrated planned path. The user observes via the terminal whether the autonomous mobile device moves within the working area defined by the actual physical boundary line. If so, the autonomous mobile device continues traveling. If not, the calibration mechanism is indicated to have failed, and the autonomous mobile device is caused to shut down.

In some embodiments of the present disclosure, the intelligent control method further includes: causing the autonomous mobile device to travel and perform tasks along the calibrated planned path, and repeating operations 102 to 103.

In some embodiments, during the autonomous mobile device traveling and performing tasks along the calibrated planned path, in response to the autonomous mobile device contacting the first physical boundary line again, the aforementioned operations 102 to 103 is similarly applied to the calibrated planned path. The calibration process is repeated iteratively until the autonomous mobile device completes the mowing tasks across the entire working area.

Through the aforementioned intelligent control method, if the actual coordinates of the autonomous mobile device are inconsistent with the preset coordinates within the virtual map when the autonomous mobile device has reached the first physical boundary line, the planned path is calibrated to prevent the autonomous mobile device from moving beyond the physical boundary lines. The calibration process for the planned path is performed in real time, ensuring the autonomous mobile device travels and performs mowing tasks efficiently along the planned path while preventing the autonomous mobile device from exiting the physical boundary lines caused by positioning errors. This enables the autonomous mobile device to maximize coverage of the mowing area, enhancing operational efficiency of the autonomous mobile device and reducing the damage risk to the autonomous mobile device.

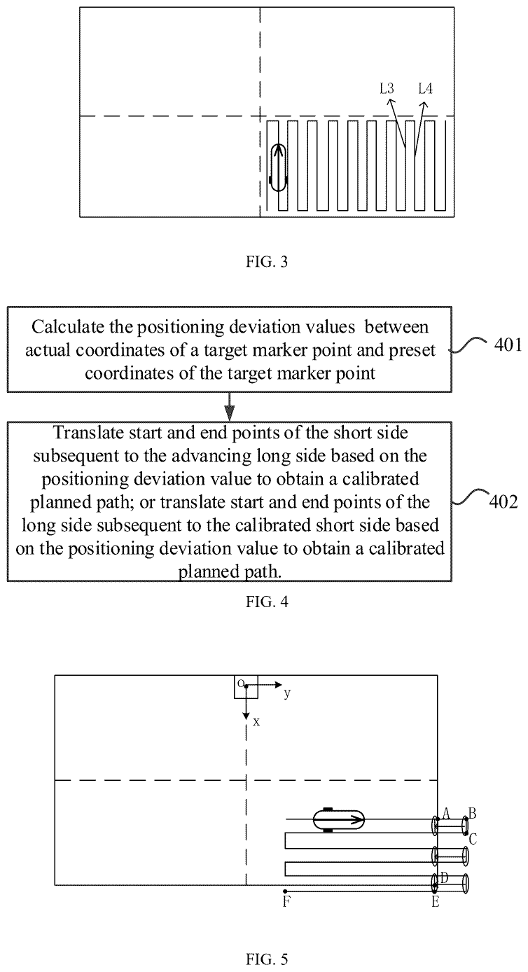

Referring to FIGS. 2 and 3, in some embodiments of the present disclosure, the planned path includes at least a reciprocating parallel planned path with alternating travel directions and a zigzag planned path.

Taking the reciprocating parallel planned path with alternating travel directions as an example, the reciprocating parallel planned path with alternating travel directions includes long sides and short sides, where a spacing between two adjacent long sides is set based on the width of a cutter disc of the autonomous mobile device.

In some embodiments, the spacing between the two adjacent long sides (e.g., long side L1 and long side L2 in FIG. 2, or long side L3 and long side L4 in FIG. 3) is in a range of (0, D], such as 0.7D, 0.8D, 0.9D, or D, where D is the width of the cutter disc of the autonomous mobile device. Alternatively, the spacing between the two subsequent long sides (e.g., long side L1 and long side L2 in FIG. 2, or long side L3 and long side L4 in FIG. 3) is in a range of (0, 45 cm], such as 20 cm, 22 cm, 25 cm, 30 cm, 35 cm, 40 cm, or 45 cm.

In some embodiments, the coordinate position information for each turning point of the reciprocating parallel planned path with alternating travel directions is pre-stored as a coordinate set in the memory of the autonomous mobile device. The coordinate position information of the turning points is sequentially read from the memory, thereby switching travelling paths according to the length and spacing of the planned path.

During the autonomous mobile device traveling along an advancing long side in the long sides of the planned path, if the actual coordinates of the first marker point are inconsistent with the preset coordinates of the first marker point, a calibration process for a short side subsequent to the advancing long side is implemented, to obtain a calibrated short side.

In some embodiments, taking a regular rectangular working area as an example (see FIGS. 2 and 3), the reciprocating parallel planned path with alternating travel directions includes a left-right reciprocating parallel planned path with alternating travel directions (as shown in FIG. 2) and an up-down reciprocating parallel planned path with alternating travel directions (as shown in FIG. 3).

It should be understood that the direction of the reciprocating parallel planned path with alternating travel directions is not limited to those shown in FIGS. 2 and 3. Any reciprocating parallel planned path with alternating travel directions with an arbitrary angular deviation from the direction of the planned paths shown in FIG. 2 or FIG. 3 is applicable to the intelligent control method proposed in the present disclosure.

While the autonomous mobile device is traveling along the long side of the left-right reciprocating parallel planned path with alternating travel directions, the first physical boundary line is the left-right physical boundary line, with the short side parallel to the left-right physical boundary line and the long side perpendicular to the left-right physical boundary line. While the autonomous mobile device is traveling along the long side of the up-down reciprocating parallel planned path with alternating travel directions, the first physical boundary line is the up-down physical boundary line, with the short side parallel to the up-down physical boundary line and the long side perpendicular to the up-down physical boundary line.

In some embodiments, while the autonomous mobile device is traveling along the long side of a left-right reciprocating parallel planned path with alternating travel directions or an up-down reciprocating parallel planned path with alternating travel directions, if the autonomous mobile device reaches the first physical boundary line, and the actual coordinates of the autonomous mobile device are inconsistent with the pre-stored coordinates (located at the boundary of the virtual map) that the autonomous mobile device should have reached along the current planned path, it indicates positioning deviation has occurred. At this point, the autonomous mobile device continuing to travel along the long side of the reciprocating parallel planned path with alternating travel directions cause the autonomous mobile device to exit the physical boundary lines, resulting in ineffective mowing. Therefore, the autonomous mobile device should be caused to turn in response to contacting the first physical boundary line, and the short side subsequent to the long side along which the autonomous mobile device is currently traveling in the aforementioned planned path should undergo translation processing to shift the short side into the working area, ensuring the autonomous mobile device stays within the working area while the autonomous mobile device is traveling along the short side.

In some embodiments, the intelligent control method further includes: during the autonomous mobile device traveling along the long side of a left-right reciprocating or up-down reciprocating parallel planned path with alternating travel directions, detecting obstacle information in real time via obstacle sensors. The intelligent control method further includes: in response to detecting an obstacle, causing the autonomous mobile device to travel along the edge of the obstacle until the autonomous mobile device returns to the straight line of the long side of the reciprocating parallel planned path with alternating travel directions, and causing the autonomous mobile device to continue traveling along the long side of the reciprocating parallel planned path with alternating travel directions until the autonomous mobile device contacts the first physical boundary line.

In some embodiments, the method provided in the present disclosure enables real-time updates of the short side subsequent to the long side along which the autonomous mobile device is currently traveling in the reciprocating parallel planned path with alternating travel directions while causing the autonomous mobile device to travel and perform mowing tasks along the long side. This prevents the autonomous mobile device from straying beyond the boundary during long-side travel, results in a neater, more regular mowing path, avoids duplicate or missed mowing, and improves both coverage and operational efficiency of the autonomous mobile device.

In some embodiments of the present disclosure, the intelligent control method further includes: after completing the calibration process on the calibrated short side, during the autonomous mobile device traveling along the calibrated short side, in response to detecting that the autonomous mobile device has reached a second physical boundary line before arriving at a turning point of the planned path, actual coordinates of the second marker point and preset coordinates of the second marker point within the virtual map are acquired, where the second physical boundary line intersects with the first physical boundary line and the second marker point is configured to indicate the position where the autonomous mobile device reaches the second physical boundary line.

The intelligent control method further includes: if the actual coordinates of the second marker point are inconsistent with the preset coordinates, implementing a calibration process on a long side subsequent to the calibrated short side, to obtain a calibrated long side.

In some embodiments, while the autonomous mobile device is traveling along the short side of the left-right reciprocating parallel planned path with alternating travel directions, the second physical boundary line is the up-down physical boundary line, with the long side parallel to the up-down physical boundary line and the short side perpendicular to the up-down physical boundary line. While the autonomous mobile device is traveling along the short side of the up-down reciprocating parallel planned path with alternating travel directions, the second physical boundary line is the left-right physical boundary line, with the long side parallel to the left-right physical boundary line and the short side perpendicular to the left-right physical boundary line.

In some embodiments, while the autonomous mobile device is traveling along the short side of a left-right reciprocating or up-down reciprocating parallel planned path with alternating travel directions, if the actual coordinates of the autonomous mobile device at the second physical boundary line are inconsistent with the pre-stored position coordinates (located at the boundary of the virtual map) that the autonomous mobile device should have reached along the current planned path, the autonomous mobile device is configured to turn in response to contacting the second physical boundary line, and the next long side subsequent to the short side of the planned path undergo translation processing to shift the next long side into the working area, preventing the autonomous mobile device from crossing the boundary.

In some embodiments, the method provided by the embodiments of the present disclosure further enables real-time updates of the long side subsequent to the calibrated short side of the reciprocating parallel planned path with alternating travel directions while causing the autonomous mobile device to perform mowing tasks along the short side of the calibrated reciprocating parallel planned path with alternating travel directions, further ensuring the autonomous mobile device performs mowing tasks within the working area.

Referring to FIG. 4, in some embodiments of the present disclosure, the calibration process for the planned path includes the following operations 401 to 402.

In 401, the positioning deviation values (Dₓ, D_{y}) between the actual coordinates of a target marker point and the preset coordinates of the target marker point are calculated by a calculation formula:

$$( {D}_{x} , {D}_{y} ) = \vert ( {x}_{2} - {x}_{{}_{1 ,}} {y}_{2} - {y}_{1} ) \vert .$$

In the embodiments of the present disclosure, the target marker point is configured to indicate the position where the autonomous mobile device reaches the physical boundary line. Dₓ represents the positioning deviation value along the x-axis, and D_{y} represents the positioning deviation value along the y-axis. (x_{1,} y₁) denotes the actual coordinates of the target marker point, e.g., point A shown in FIG. 5. (x_{2,} y₂) denotes the preset coordinates of the target marker point, e.g., point B shown in FIG. 5. Both (x_{1,} y₁) and (x_{2,} y₂) are defined based on the coordinate system as shown in FIG. 5.

Taking FIG. 5 as an example, the origin of the coordinate system is located at the charging station. The positive x-axis direction of the coordinate system is defined as the direction in which the autonomous mobile device departs from the charging station, while the positive y-axis direction is perpendicular to the positive x-axis and oriented counterclockwise relative to the positive x-axis. It should be understood that the charging station is not limited to being located at the upper physical boundary line. When the charging station is located at the left-right physical boundary lines or the lower physical boundary line, the principle for setting the coordinate axis directions remains the same as above.

In some embodiments, as shown in FIG. 5, taking a left-right reciprocating parallel planned path with alternating travel directions as an example, when the autonomous mobile device travels along the long side of the planned path and contacts the first physical boundary line (the right physical boundary line shown in FIG. 5), for example, the autonomous mobile device reaches point A in FIG. 5, the positioning deviation value is calculated.

In 402, translating processing is performed on start and end points of the short side subsequent to the advancing long side of the planned path based on the positioning deviation value, or translating processing is performed on start and end points of the long side subsequent to the calibrated short side of the planned path based on the positioning deviation value, to obtain a calibrated planned path.

In some embodiments, as shown in FIG. 5 (taking the left-right reciprocating parallel planned path with alternating travel directions as an example), the start and end points of the next short side of the planned path proposed in operation 402 are points B and C shown in FIG. 5. By translating the entire BC segment leftward by D_{y} relative to the first physical boundary line (the right physical boundary line shown in FIG. 5), it is ensured that the autonomous mobile device remains confined within the working area when traveling and performing the mowing task along the calibrated planned path.

In some embodiments, still referring to FIG. 5, taking the left-right reciprocating parallel planned path with alternating travel directions as an example, the autonomous mobile device continuously makes contact with the right physical boundary line while traveling along the long side of the reciprocating parallel planned path with alternating travel directions within the sub-working area shown in FIG. 5. Only when the autonomous mobile device approaches the lower physical boundary line the autonomous mobile device contact the lower physical boundary line while traveling along the final short side of the reciprocating parallel planned path with alternating travel directions, leading to an out-of-boundary situation—and such situations have a relatively minor impact on operation.

In some embodiments, for such situations and still referring to FIG. 5, the calibration process for the planned path further include: when the autonomous mobile device travels along the short side of the left-right reciprocating parallel planned path with alternating travel directions and contacts the second physical boundary line (the lower physical boundary line shown in FIG. 5), the positioning deviation values (D′ₓ, D′_{y}) between the actual coordinates and preset coordinates of the autonomous mobile device at the point of contact with the second physical boundary line are calculated using the same logic as described above, where a calculation formula is:

$$( {D}_{x}^{′} , {D}_{y}^{′} ) = \vert ( {x}_{4} - {x}_{{3 ,}_{}} {y}_{4} - {y}_{3} ) \vert .$$

In the embodiments of the present disclosure, (x_{3,} y₃) represents the actual coordinates of the autonomous mobile device at the contact point with the second physical boundary line, e.g., point D shown in FIG. 5; (x_{4,} y₄) represents the preset coordinates, e.g., point E shown in FIG. 5. Both (x_{3,} y₃) and (x_{4,} y₄) are also defined based on the aforementioned coordinate system as shown in FIG. 5.

Translating the start and end points of the next long side of the reciprocating parallel planned path with alternating travel directions—i.e., segment EF in FIG. 5—upward as a whole by D′ₓ relative to the lower physical boundary line ensures the autonomous mobile device remains within the working area during movement.

In some embodiments, while the autonomous mobile device is traveling along the up-down reciprocating parallel planned path with alternating travel directions, the calibration logic for the up-down reciprocating parallel planned path with alternating travel directions is identical to that described above for the left-right reciprocating parallel planned path with alternating travel directions and is not repeated here.

In some embodiments, the method provided by the embodiments of the present disclosure implements real-time translation processing on the reciprocating parallel planned path with alternating travel directions to promptly pull the travel path of the autonomous mobile device back within the working area. This prevents the autonomous mobile device from exiting the physical boundaries and causing ineffective mowing.

In some embodiments of the present disclosure, the method further includes: If both Dₓ and D_{y} are less than a preset threshold, translate the short side subsequent to the advancing long side based on the positioning deviation values (Dₓ, D_{y}), or translating the long side subsequent to the calibrated short side based on based on the positioning deviation values (Dₓ, D_{y}), to obtain the calibrated planned path.

In some embodiments, as shown in FIG. 5, taking a left-right reciprocating parallel planned path with alternating travel directions as an example, when causing the autonomous mobile device to travel and perform mowing tasks along the aforementioned reciprocating parallel planned path with alternating travel directions within the working area, a repositioning operation is implemented. However, if a positioning deviation occurs between the actual coordinates of the autonomous mobile device at the contacted physical boundary line and the preset coordinates of the autonomous mobile device, this result in low operational efficiency of the autonomous mobile device.

If both positioning deviation values Dₓ and D_{y} fall below the preset threshold, indicating the deviation remains within acceptable limits, the next segment of the reciprocating parallel planned path with alternating travel directions is translated according to actual conditions to guide the autonomous mobile device back into the working area.

If the autonomous mobile device contacts the first physical boundary line (e.g. the right physical boundary line shown in FIG. 5) while traveling along the long side of the reciprocating parallel planned path with alternating travel directions, the next short side undergo translation processing.

Furthermore, if the autonomous mobile device contacts the second physical boundary line (e.g. the lower physical boundary line shown in FIG. 5) while traveling along the short side of the reciprocating parallel planned path with alternating travel directions, the next long side undergo translation processing.

If either Dₓ or D_{y} exceeds the preset threshold, a repositioning operation is activated.

If either Dₓ or D_{y} exceeds the preset threshold, the positioning error is significant. Even if the next segment of the reciprocating parallel planned path with alternating travel directions is translated, calibration anomalies occur, and the autonomous mobile device still cross the boundary. Therefore, a repositioning operation is implemented to correct the positioning output of the autonomous mobile device.

In some embodiments, the method provided herein determines whether to implement a calibration process for the planned path or a repositioning operation based on the relationship between the positioning deviation values and the preset threshold, thereby avoiding multiple repositioning operations that can reduce the operational efficiency of the autonomous mobile device.

In some embodiments of the present disclosure, the repositioning operation includes: causing the autonomous mobile device to travel along the physical boundary line, detecting radio frequency identification (RFID) tag signals in real time, acquiring the actual coordinates pre-stored in the RFID tags, and replacing the current coordinates of the autonomous mobile device with the actual coordinates pre-stored in the RFID tags.

In some embodiments, multiple RFID tags are placed along the boundary of the working area of the autonomous mobile device at preset interval distances. These RFID tags are feature ground stakes incorporating RFID radio frequency coils. It should be understood that each RFID tag possesses a unique identification (ID).

When a repositioning operation is required, the autonomous mobile device is caused to travel along the physical boundary line, with real-time RFID tag detection processing implemented during traversal. In response to detecting any RFID tag, the current coordinates of the autonomous mobile device are replaced to the coordinates of that RFID tag, thereby completing the repositioning operation. After completing the repositioning operation, the autonomous mobile device is caused to return to the working area and perform mowing tasks along a planned path again.

In some embodiments, the repositioning operation provided by the embodiments of the present disclosure corrects the position of the autonomous mobile device, when the autonomous mobile device meets predefined conditions, thereby preventing excessive positioning errors that can cause abnormal operation of the autonomous mobile device.

In some embodiments of the present disclosure, the intelligent control method further includes: calculating a mowing coverage rate of a sub-working area within the virtual map.

In some embodiments, the mowing coverage rate represents a ratio of the mowing coverage area of the autonomous mobile device within a sub-working area during a current mowing operation to the total area of the sub-working area.

When the mowing coverage rate is less than a preset value, the method further includes: implementing a repositioning operation and causing the autonomous mobile device to perform another mowing task within the sub-working area, where the path direction of the another mowing task differs from that of previous mowing task.

In some embodiments, the preset value is set according to actual user requirements, such as 80%. When the mowing coverage rate of the autonomous mobile device within a sub-working area falls below 80%, the presence of uncut grass areas is indicated. At this point, the autonomous mobile device is caused to implement a repositioning operation according to the method described in the above embodiment, to eliminate positioning errors and correct the positioning output of the autonomous mobile device.

After completing the repositioning operation, the autonomous mobile device is caused to return to the sub-working area and perform a mowing task on the sub-working area again, ensuring maximum mowing coverage. If the planned path for the previous mowing task is the left-right reciprocating parallel planned path with alternating travel directions shown in FIG. 3, the planned path for the mowing task is the up-down reciprocating parallel planned path with alternating travel directions shown in FIG. 4 or any other reciprocating parallel planned path with alternating travel directions with an arbitrary angular deviation relative to the planned path of the previous mowing task. Similarly, if the planned path of the previous mowing task is the up-down reciprocating parallel planned path with alternating travel directions shown in FIG. 4, the planned path of the mowing task is the left-right reciprocating parallel planned path with alternating travel directions shown in FIG. 3 or any other reciprocating parallel planned path with alternating travel directions with an arbitrary angular deviation relative to the planned path of the previous mowing task.

In some embodiments, when the mowing coverage rate of the autonomous mobile device is less than the preset value, the autonomous mobile device is caused to perform a second mowing task in a different mowing direction, thereby improving the mowing coverage rate of the working area.

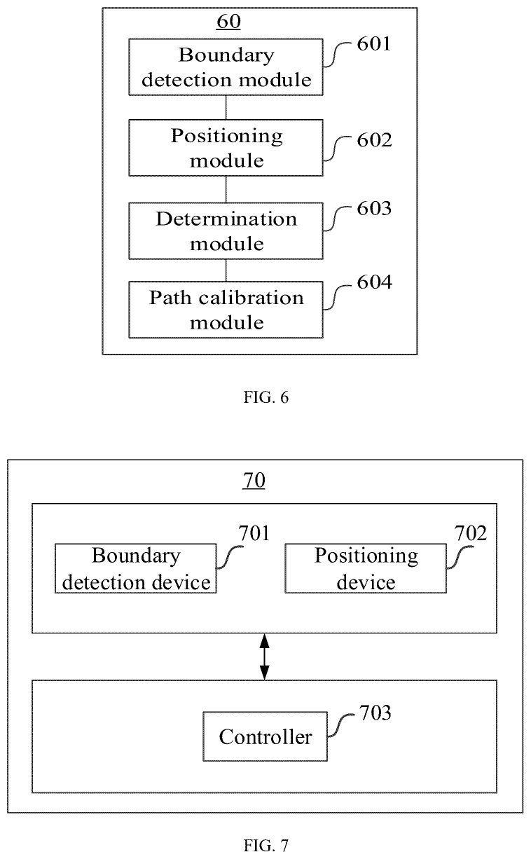

Referring to FIG. 6, the embodiments of the present disclosure further provide an intelligent control device 60 for an autonomous mobile device. The intelligent control device 60 includes a boundary detection module 601, a positioning module 602, a determination module 603 and a path calibration module 604.

The boundary detection module 601 is configured to detect a physical boundary line.

In some embodiments, the boundary detection module 601 includes two boundary sensors mounted at the front end of the housing of the autonomous mobile device and symmetrically arranged relative to the longitudinal centerline of the housing.

The positioning module 602 is configured to acquire real-time position information of the autonomous mobile device.

In some embodiments, the positioning module 602 includes at least an odometer and an inertial measurement unit (IMU). The odometer is configured to measure the distance traveled by the autonomous mobile device, and the IMU is configured to sense the azimuth of the autonomous mobile device. The data from the odometer and the IMU are fused to obtain the real-time position information of the autonomous mobile device.

The determination module 603 is connected to the positioning module 602, and is configured to receive the actual coordinates of the marker point output by the positioning module 602, and determine whether the actual coordinates match the preset coordinates of the marker point within the virtual map. The marker point is configured to indicate the position where the autonomous mobile device reaches the physical boundary line.

The path calibration module 604 is connected to the determination module 603, and is configured to activate a calibration process for the planned path when the determination module determines that the actual coordinates are inconsistent with the preset coordinates of the marker point within the virtual map, calibrate the planned path based on the positioning deviation value between the actual coordinates and the preset coordinates of the marker point, and cause the autonomous mobile device to travel and perform tasks along the calibrated planned path.

Referring to FIG. 7, the embodiments of the present disclosure further provide an autonomous mobile device that performs mowing tasks within a working area defined by the physical boundary lines. The autonomous mobile device 70 includes at least: a boundary detection device 701, a positioning device 702, and a controller 703.

The boundary detection device 701 is configured to detect the physical boundary lines.

The positioning device 702, including an odometer and an IMU, is configured to output real-time position information of the autonomous mobile device 70.

The controller 703, electrically connected to the boundary detection device 701 and the positioning device 702, is configured to implement the following operations:
Causing the autonomous mobile device to travel and perform mowing tasks along a planned path, where the planned path is initially set based on a virtual map;
During the autonomous mobile device traveling along the planned path, in response to detecting that the autonomous mobile device has reached a first physical boundary line before arriving at a turning point of the planned path, acquiring the actual coordinates of the first marker point and the preset coordinates of the first marker point within the virtual map. The first marker point being configured to indicate the position where the autonomous mobile device reaches the first boundary line;
If the actual coordinates of the first marker point are inconsistent with the preset coordinates, activating a calibration process for the planned path.

More detailed operations implemented by the controller are not elaborated here and should be referenced in the description of the aforementioned intelligent control methods.

The embodiments of the present disclosure further provide an autonomous mobile device including a memory and a processor. The memory is configured to store computer-executable instructions, and the processor is configured to call the computer-executable instructions in the memory to cause the autonomous mobile device to implement the intelligent control methods as described in any of the above embodiments.

In the embodiments of the present disclosure, the autonomous mobile device travels along a planned path, and real-time detection is implemented to determine whether the autonomous mobile device has reached a physical boundary line. The actual coordinates of the autonomous mobile device at the physical boundary line are acquired. If the actual coordinates at the physical boundary line are inconsistent with the preset coordinates within the virtual map (where the autonomous mobile device should arrive), a calibration process for the planned path is implemented to prevent the autonomous mobile device from moving beyond the physical boundary line. The calibration process for the planned path is implemented in real time. This ensures the autonomous mobile device efficiently performs tasks along the planned path while preventing the autonomous mobile device from moving beyond the physical boundary lines due to positioning errors. Consequently, the autonomous mobile device maximizes coverage of the working area, which enhances the operational efficiency of the autonomous mobile device and reduces the risk of damage to the autonomous mobile device.

The present disclosure is not limited to the specific embodiments described above. Persons of ordinary skill in the art can easily understand that, without departing from the spirit and scope of the present disclosure, there are many alternative solutions for the intelligent control method described in the present disclosure. The protection scope of the present disclosure should be subject to the scope defined by the claims.

What is claimed is:

1. An intelligent control method, applied to an autonomous mobile device, and comprising operations:
101, causing the autonomous mobile device to travel and perform tasks along a planned path, wherein the planned path is initially set based on a virtual map;
102, during the autonomous mobile device traveling along the planned path, in response to detecting that the autonomous mobile device has reached a first boundary line before arriving at a turning point of the planned path, acquiring actual coordinates of a first marker point and preset coordinates of the first marker point within the virtual map, wherein the first marker point is configured to indicate a position where the autonomous mobile device has reached the first boundary line; and
103, in response to the actual coordinates of the first marker point being inconsistent with the preset coordinates, activating a calibration process for the planned path to obtain a calibrated planned path.

2. The intelligent control method according to claim 1, further comprising:
causing the autonomous mobile device to travel and perform tasks along the calibrated planned path, and repeating the operations 102 to 103.

3. The intelligent control method according to claim 1, wherein the planned path comprises long sides and short sides, and a spacing between two adjacent long sides is set based on a width of a cutter disc of the autonomous mobile device.

4. The intelligent control method according to claim 3, wherein the spacing is greater than 0 and less than or equal to D, where D is the width of the cutter disc of the autonomous mobile device.

5. The intelligent control method according to claim 3, wherein the spacing is greater than 0 and less than or equal to 45 cm.

6. The intelligent control method according to claim 3, further comprising:
in response to detecting an obstacle while the autonomous mobile device traveling along an advancing long side in the long sides of the planned path, causing the autonomous mobile device to move along an edge of the obstacle until the autonomous mobile device returns to the advancing long side; and
causing the autonomous mobile device to continue traveling along the advancing long side until the autonomous mobile device contacts the first boundary line.

7. The intelligent control method according to claim 3, wherein the calibration process in the operation 103 comprises:
during the autonomous mobile device traveling along an advancing long side in the long sides of the planned path, in response to the actual coordinates of the first marker point being inconsistent with the preset coordinates, implementing the calibration process on a short side subsequent to the advancing long side, to obtain a calibrated short side.

8. The intelligent control method according to claim 7, further comprising:
after completing the calibration process on the calibrated short side, during the autonomous mobile device traveling along the calibrated short side, in response to detecting that the autonomous mobile device has reached a second boundary line before arriving at a turning point of the planned path, acquiring actual coordinates of a second marker point and preset coordinates of the second marker point within the virtual map, wherein the second boundary line intersects with the first boundary line, and the second marker point is configured to indicate the position where the autonomous mobile device reaches the second boundary line; and
in response to the actual coordinates of the second marker point being inconsistent with the preset coordinates, implementing the calibration process on a long side subsequent to the calibrated short side, to obtain a calibrated long side.

9. The intelligent control method according to claim 8, wherein the calibration process comprises the following operations:
calculating positioning deviation values (Dₓ, D_{y}) between actual coordinates of a target marker point and preset coordinates of the target marker point by a calculation formula:
$$( {D}_{x} , {D}_{y} ) = \vert ( {x}_{2} - {x}_{{}_{1 ,}} {y}_{2} - {y}_{1} ) \vert ;$$
wherein the target marker point comprises the first marker point and the second marker point, and the target marker point is configured to indicate the position where the autonomous mobile device reaches the boundary line, Dₓ represents a positioning deviation value along the x-axis, and D_{y} represents a positioning deviation value along the y-axis, (x_{1,} y₁) denotes the actual coordinates of the target marker point, (x_{2,} y₂) denotes the preset coordinates of the target marker point within the virtual map, and |(x₂−x_{1,} y₂−y₁)| represents an absolute value of (x₂−x_{1,} y₂−y₁); and
translating start and end points of the short side subsequent to the advancing long side based on the positioning deviation value to obtain a calibrated planned path, or
translating start and end points of the long side subsequent to the calibrated short side based on the positioning deviation value to obtain a calibrated planned path.

10. The intelligent control method according to claim 9, further comprising:
in response to both Dₓ and D_{y} being less than a preset threshold, translating the short side subsequent to the advancing long side based on the positioning deviation values, or translating the long side subsequent to the calibrated short side based on the positioning deviation values, to obtain the calibrated planned path; and
in response to either Dₓ or D_{y} exceeding the preset threshold, triggering a repositioning operation.

11. The intelligent control method according to claim 1, further comprising:
calculating a mowing coverage rate of a working area within the virtual map; and
in response to the mowing coverage rate being less than a preset value, implementing a repositioning operation, and causing the autonomous mobile device to perform a mowing task within the working area again, wherein the path direction of the mowing task differs from the path direction of previous mowing task.

12. An autonomous mobile device, comprising:
a boundary detection device, configured to detect a boundary line;
a positioning device, configured to output real-time position information of the autonomous mobile device;
a controller, electrically connected to the boundary detection device and the positioning device, and configured to implement the following operations:
causing the autonomous mobile device to perform tasks along a planned path, wherein the planned path is initially set based on a virtual map;
during the autonomous mobile device traveling along the planned path, in response to detecting that the autonomous mobile device has reached a first boundary line before arriving at a turning point of the planned path, acquiring actual coordinates of a first marker point and preset coordinates of the first marker point within the virtual map, wherein the first marker point is configured to indicate the position where the autonomous mobile device has reached the first boundary line; and
in response to the actual coordinates of the first marker point being inconsistent with the preset coordinates, activating a calibration process for the planned path to obtain a calibrated planned path.

13. The autonomous mobile device according to claim 12, wherein the autonomous mobile device interacts with a terminal, and the terminal displays the position of the intelligent control device relative to the boundary line in real time; and the operations further include:
before activating the calibration process, causing the autonomous mobile device or the terminal to send an alarm signal, wherein the alarm signal includes at least one of a buzzer alarm, vibration, a voice prompt, and LED flashing, and the alarm signal is configured to indicate that the autonomous mobile device has exited the boundary line.

14. The autonomous mobile device according to claim 12, wherein the operations further comprise:
after completing the calibration process, in response to the autonomous mobile device receiving a first signal, causing the autonomous mobile device to shut down, wherein the first signal is configured to indicate that the autonomous mobile device has exited the boundary line.

15. The autonomous mobile device according to claim 12, wherein the calibration process comprises at least:
during the autonomous mobile device traveling along an advancing long side in the long sides of the planned path, in response to the actual coordinates of the first marker point being inconsistent with the preset coordinates, implementing the calibration process on a short side subsequent to the target long side, to obtain a calibrated short side.

16. The autonomous mobile device according to claim 15, wherein the operations further comprise:
after completing the calibration process on the calibrated short side, during the autonomous mobile device travelling along the calibrated short side, upon the boundary detection device detecting that the autonomous mobile device has reached a second boundary line before arriving at a turning point of the planned path, acquiring the actual coordinates of a second marker point and the preset coordinates of the second marker point within the virtual map, wherein the second boundary line intersects with the first boundary line, and the second marker point is configured to indicate the position where the autonomous mobile device reaches the second boundary line; and
in response to the actual coordinates of the second marker point being inconsistent with the preset coordinates, implementing the calibration process on a long side subsequent to the calibrated short side, to obtain a calibrated long side.

17. The autonomous mobile device according to claim 16, wherein the calibration process comprises the following operations:
calculating positioning deviation values (Dₓ, D_{y}) between actual coordinates of a target marker point and preset coordinates of the target marker point by a calculation formula:
$$( {D}_{x} , {D}_{y} ) = \vert ( {x}_{2} - {x}_{{}_{1 ,}} {y}_{2} - {y}_{1} ) \vert ;$$
wherein the target marker point comprises the first marker point and the second marker point, and the target marker point is configured to indicate the position where the autonomous mobile device reaches the boundary line, Dₓ represents a positioning deviation value along the x-axis, D_{y} represents a positioning deviation value along the y-axis, (x_{1,} y₁) denotes the actual coordinates of the target marker point, (x_{2,} y₂) denotes the preset coordinates of the target marker point within the virtual map, and |(x₂−x_{1,} y₂−y₁)| represents an absolute value of (x₂−x_{1,} y₂−y₁); and
translating start and end points of the short side subsequent to the advancing long side based on the positioning deviation value to obtain a calibrated planned path; or
translating start and end points of the long side subsequent to the calibrated short side based on the positioning deviation value to obtain a calibrated planned path.

18. The autonomous mobile device according to claim 17, wherein the operations further comprise:
in response to both Dₓ and D_{y} being less than a preset threshold, translating the short side subsequent to the advancing long side based on the positioning deviation value, or translating the long side subsequent to the calibrated short side based on the positioning deviation value, to obtain the calibrated planned path; and
in response to either Dₓ or D_{y} exceeding the preset threshold, triggering a repositioning operation.

19. The autonomous mobile device according to claim 12, wherein the operations further comprise:
calculating a mowing coverage rate of a working area within the virtual map; and
in response to the mowing coverage rate being less than a preset value, implementing a repositioning operation, and causing the autonomous mobile device to perform a mowing task within the working area again, wherein the path direction of the mowing task differs from the path direction of previous mowing task.

20. An autonomous mobile device, comprising a memory and a processor, wherein the memory is configured to store computer-executable instructions, and the processor is configured to call the computer-executable instructions in the memory to cause the autonomous mobile device to implement the intelligent control method according to claim 1.
